(19) United States
(12) Patent Application Publication
(10) Pub. No.: US 2016/0318761 A1
(43) Pub. Date: Nov. 3, 2016

(54) HYDROGEN PRODUCTION METHOD AND HYDROGEN PRODUCTION SYSTEM

(71) Applicants: KYOTO UNIVERSITY, Kyoto-shi (JP); AQUAFAIRY CORPORATION, Kyoto-shi (JP); ROHM CO., LTD., Kyoto-shi (JP)

(72) Inventors: Kazuyuki HIRAO, Kizugawa-shi (JP); Kohji NAGASHIMA, Kyotanabe-shi (JP); Hitoshi ISHIZAKA, Suzuka-shi (JP); Kazuo OKADA, Osaka-shi (JP); Takashi SAEKI, Akashi-shi (JP)

(73) Assignees: KYOTO UNIVERSITY, Kyoto-shi (JP); AQUAFAIRY CORPORATION, Kyoto-shi (JP); ROHM CO., LTD., Kyoto-shi (JP)

(21) Appl. No.: 15/108,465

(22) PCT Filed: Dec. 26, 2014
(86) PCT No.: PCT/JP2014/084526

§ 371 Date: Jun. 27, 2016

(30) Foreign Application Priority Data
Dec. 27, 2013 (JP) 2013-272618

(51) Int. Cl. C01B 3/08; B01J 7/02

(52) U.S. Cl. CPC C01B 3/08; B01J 7/02

(57) ABSTRACT

A hydrogen production method and hydrogen production system using the reaction of water and aluminum, the hydrogen production method and system being capable of continuously generating hydrogen for a long period of time without causing a decrease in the total amount of hydrogen generation. A hydrogen generation system according to one embodiment of the present invention includes aluminum sheet placed in a container and calcium hydroxide contained in the same container. In the hydrogen production system having the previously described configuration, water is poured in the container to dissolve the calcium hydroxide so that an aqueous solution is prepared, and the aluminum sheet is immersed in this aqueous solution. As a result, the hydrogen generation reaction begins, generating hydrogen gas. The amount, rate and duration of the generation of hydrogen gas can be controlled by adjusting the area and thickness of the aluminum sheet.

### TECHNICAL FIELD

The present invention relates to a method and system for producing hydrogen used as a fuel for fuel cells or for other purposes, and specifically, to a hydrogen production method and hydrogen production system which utilize a reaction of aluminum with water.

### BACKGROUND ART

Fuel cells are a type of generating equipment for extracting power from the chemical reaction of hydrogen and oxygen. Compared to the existing types of generating equipment, fuel cells have an extremely high level of power generation efficiency as well as low amounts of noise and vibration. Additionally, they barely emit environmental pollutants. Therefore, fuel cells are expected to be used in various fields, such as mobile devices (notebook computers, mobile phones, etc.), home appliances and automobiles. One problem to be overcome for such a fuel cell is to improve the production efficiency of the hydrogen gas which serves as a fuel.

For example, Patent Literature 1 discloses a method in which a hydrogen-generating agent which contains particulate aluminum and calcium hydroxide is made to come in contact with water to generate hydrogen gas. In this method, the insoluble layer formed on the particle surface due to the reaction of the aluminum with water (a passive layer of an oxide or hydroxide of aluminum) is solubilized by the calcium hydroxide so as to form an unreacted metallic surface of aluminum and thereby improve the hydrogen generation efficiency.

### CITATION LIST

### Patent Literature

Patent Literature 1: JP 2013-6734 A

### SUMMARY OF INVENTION

### Technical Problem

In the previously described method, it is preferable to reduce the particle size of the aluminum and increase its specific surface area (i.e. surface area/volume) in order to suppress the formation of the insoluble layer and increase the total amount of hydrogen-gas generation. However, reducing the aluminum particle size causes the reaction with water to dramatically proceed, so that the reaction ceases within a short period of time. Furthermore, aluminum powder with a particle size of 150 μm or smaller is designated as a dangerous substance (Type I Combustible Solid, Danger Rating II) in the Fire Service Act of Japan (Article 1-11 of Hazardous Materials Control Order, Appended Table 3). Depending on the amount of powder which is handled, its use needs to be reported.

The problem to be solved by the present invention is provide a hydrogen production method and system using the reaction of water and aluminum, the hydrogen production method and system being capable of continuously generating hydrogen for a long period of time without causing a decrease in the total amount of hydrogen generation while facilitating the handling of the material for hydrogen generation.

### Solution to Problem

To solve the previously described problem, the present inventors have conducted intensive studies and discovered the fact that using sheet-like aluminum as the material for hydrogen generation makes it possible to sustain the hydrogen generation reaction for a long period of time as well as avoid the designation of the material as a dangerous substance. Consequently, the present invention has been created.

That is to say, the hydrogen generation method according to the first aspect of the present invention developed for solving the previously described problem includes the steps of:
preparing an aqueous solution by dissolving calcium hydroxide in water; and
immersing an aluminum sheet or a plurality of aluminum sheets having a total surface area within a range from 150 cm² to 3000 cm² in the aqueous solution to generate hydrogen gas.

The term “total surface area” means an area on which the aluminum sheet comes in contact with the aqueous solution and thereby contributes to the reaction of hydrogen-gas generation. If the aluminum sheet is a plurality of sheets of aluminum, the sum of the surface areas of the individual sheets of aluminum corresponds to the “total surface area”. For an extremely thin sheet of aluminum, the surface area of the sheet of aluminum can be approximated by two times the sheet area size.

In the previously described configuration, a desired amount of hydrogen gas can be obtained by preparing a plurality of kinds of aluminum sheet with different thicknesses, selecting one kind of aluminum sheet having a thickness corresponding to the amount of hydrogen gas to be generated, and immersing that selected kind of aluminum sheet in the aqueous solution to generate hydrogen gas. The aluminum sheet used in the present case should preferably have thicknesses ranging from 6.5 μm to 100 μm.

It is further preferable to select one kind of aluminum sheet having an appropriate thickness for the amount of hydrogen gas to be generated based on a previously determined correlation between the thickness of the aluminum sheet and the amount of hydrogen generation.

The hydrogen production system according to the second aspect of the present invention includes:
a) a container for holding water;
b) an aluminum sheet, placed in the container, having a total surface area within a range from 150 cm² to 3000 cm²; and
c) solid calcium hydroxide contained in the container.

In the hydrogen production system having the previously described configuration, water is poured into the container to dissolve the calcium hydroxide so that an aqueous solution is prepared, and the aluminum sheet is immersed in this aqueous solution. As a result, the hydrogen generation reaction begins, generating hydrogen gas. In this process, the solid calcium hydroxide held in the container does not completely but partially dissolve in the water, because calcium hydroxide is hardly soluble in water.

In this case, the container may be provided with a holding part capable of holding a plurality of sheets of aluminum in a mutually separated form. With this configuration, an appropriate number of sheets of aluminum for the amount of hydrogen gas to be generated, or aluminum sheet having an appropriate thickness for the amount of hydrogen gas to be generated can be held in the holding part.

### Advantageous Effects of the Invention

By using the aluminum sheet in place of the particulate aluminum which has been commonly used in the hydrogen production method and hydrogen production system using the reaction of aluminum and water, it becomes possible to continuously generate hydrogen gas for a long period of time. Additionally, the use of the aluminum sheet having a total surface area of 150 cm² to 3000 cm², and particularly, the use of the aluminum sheet having a thickness of 6.5 μm to 100 μm prevents the hydrogen generation reaction from ceasing halfway, whereby the hydrogen generation efficiency is improved.

### BRIEF DESCRIPTION OF DRAWINGS

FIG. 1 is a schematic configuration diagram of a hydrogen production system according to the first embodiment of the present invention.

FIG. 2 is a graph showing the relationship between the diameter of aluminum particles and the total amount of hydrogen generation, which is the result of Reference Experiment 1.

FIG. 3 is diagram illustrating the mechanism of the reaction of aluminum and water.

FIG. 4 is a graph showing the relationship between the kind of additive and the yield, which is the result of Reference Experiment 2.

FIG. 5 is a graph showing the temporal change in the total amount of hydrogen generation and the rate of hydrogen generation, which is the result of Example 1.

FIG. 6 is a graph showing the temporal change in the rate of hydrogen generation measured for various thicknesses of the aluminum sheet (aluminum foil), which is the result of Example 2.

FIG. 7 is a graph showing the relationship between the thickness of the aluminum foil and the ratio of hydrogen generation.

FIG. 8 is a graph showing the relationship between the thickness of the aluminum foil and the amount of hydrogen generation per unit area.

FIG. 9 is a graph showing the temporal change in the rate of hydrogen generation, which is the result of Example 3.

FIG. 10 is a graph showing the temporal change in the rate of hydrogen generation in the initial phase of the reaction in FIG. 9, with the time scale magnified.

FIG. 11 is a graph showing the temporal change in the rate of hydrogen generation from two sheets of aluminum foil with thicknesses of 100 μm and 300 μm, respectively.

FIG. 12 is a graph showing the relationship between the thickness of the aluminum foil and the duration of hydrogen generation.

FIG. 13A, FIG. 13B, FIG. 13C and FIG. 13D are graphs showing the temporal change in the rate of hydrogen generation and pH for various thicknesses of the aluminum sheet.

FIG. 14 is a graph showing the temporal change in the rate of hydrogen-gas generation in Example 4 conducted at various reaction temperatures.

FIG. 15 is a photograph showing the state of the aluminum foil after the reaction was completed.

FIG. 16 shows the result of an X-ray structural analysis.

FIG. 17 is a SEM image of the aluminum foil taken after the reaction.

FIG. 18 is a graph showing the temporal change in the rate of hydrogen generation, which shows the result of Example 5.

FIG. 19 is a graph showing the relationship between the area and the rate of hydrogen generation.

FIG. 20 is a schematic configuration diagram of a hydrogen production system according to the second embodiment of the present invention.

FIG. 21 is a schematic perspective view of a folder in the hydrogen production system.

FIG. 22A, FIG. 22B and FIG. 22C are diagrams illustrating a method for preparing a roll of aluminum, and FIG. 22D is a schematic perspective view of the roll of aluminum held in the folder.

FIG. 23 is a graph showing the temporal change in the rate of hydrogen generation, which is the result of Example 6.

FIG. 24A-24E are photographs of the aluminum taken after the reaction was completed in Example 6, where FIG. 24A is a photograph showing the roll vertically cut and spread like a strip, FIG. 24B is a photograph showing the inside of one of the layers of the strip-shaped aluminum (the portion indicated by the arrow in FIG. 24A), FIG. 24C is a photograph showing an enlarged view of the cut surface shown in FIG. 24A, FIG. 24D is a photograph showing the outermost portion of the roll, and FIG. 24E is a photograph showing an enlarged view of an unreacted portion.

FIG. 25A, FIG. 25B and 25C are diagrams illustrating a method for preparing a roll of aluminum of Example 7.

FIG. 26 is a graph showing the temporal change in the rate of hydrogen generation, which is the result of Example 7.

FIGS. 27A-27D are photographs of the aluminum taken after the reaction was completed in Example 7, where FIG. 27A is a photograph showing the roll, a portion of which is vertically cut and spread like a strip, FIG. 27B is a photograph showing the roll fully cut to its center, FIG. 27C is a photograph showing a reacted portion, and FIG. 27D is a photograph showing an unreacted portion.

FIG. 28 is a graph showing the temporal change in the rate of hydrogen generation, which is the result of Example 8.

FIG. 29A and 29B are graphs showing the result of Example 9(I), where FIG. 29A shows the temporal change in the rate of hydrogen generation and FIG. 29B shows the temporal change in the total amount of hydrogen generation.

FIG. 30 is a graph showing the temporal change in the rate of hydrogen generation, which is the result of Example 9(II).

### DESCRIPTION OF EMBODIMENTS

As already explained, in the present invention, aluminum sheet is used in place of the particulate aluminum as the material which is made to come in contact with water to generate hydrogen gas. Hereinafter, embodiments of the present invention are described in detail.

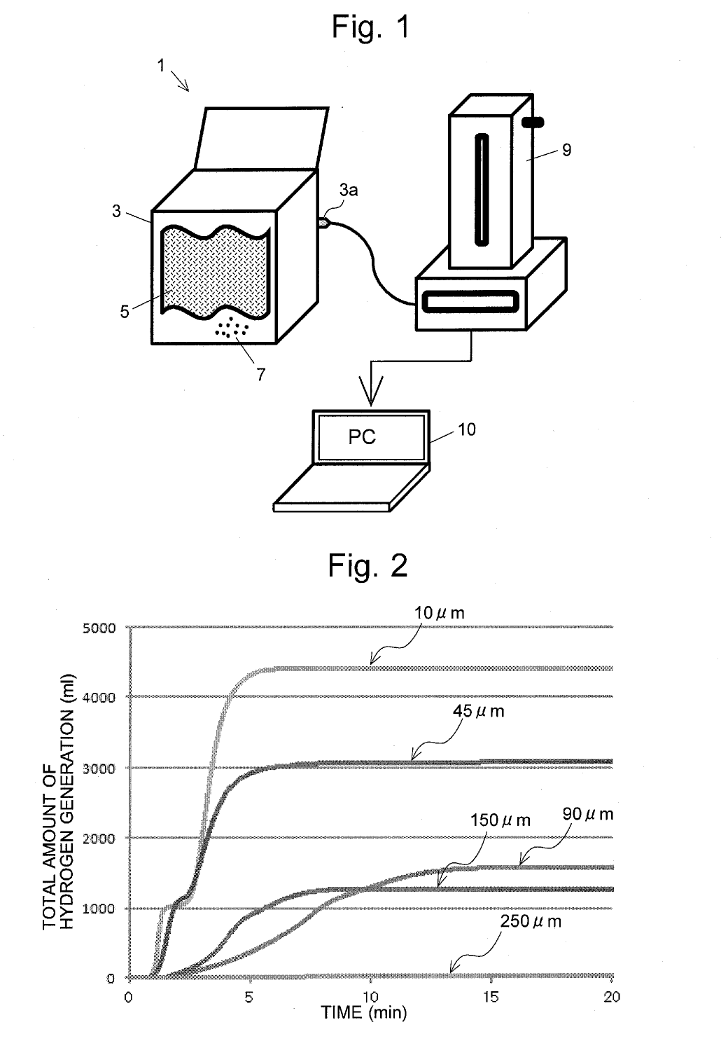

Initially, a hydrogen production system according to the first embodiment of the present invention is described with reference to FIG. 1. This hydrogen production system 1 includes an acrylic container 3 with a lid, as well as aluminum sheet 5 and particulate calcium hydroxide 7 which are placed in the container 3. The container 3 in FIG. 1 has a rectangular cylindrical shape, although it may have a different shape, such as a circular cylindrical shape. The container 3 has a holder (not shown) capable of holding a plurality of aluminum sheets 5, allowing an appropriate number of aluminum sheet 5 to be held according to the amount of hydrogen gas to be generated. The container 3 has a discharge port 3a for discharging the generated hydrogen gas.

To generate hydrogen gas with this hydrogen production system 1, water is poured into the container 3 and calcium hydroxide 7 is dissolved in it to prepare an aqueous solution. As a result, the aluminum comes in contact with the water and the hydrogen generation reaction begins, generating hydrogen gas. The generated hydrogen gas is discharged from the discharge port 3a and supplied to a device, such as a fuel cell. It should be noted that the diaphragm-type meter 9 and personal computer (PC) 10 in FIG. 1, which are respectively connected to the discharge port 3a and the hydrogen production system 1 in order to measure the amount of generated hydrogen gas, are not components of the hydrogen production system.

Specific examples of the reaction of generating hydrogen gas using the hydrogen production system 1 are hereinafter described.

Initially, in advance of the examples using the aluminum sheet which characterizes the present embodiment, reference experiments using particulate aluminum were conducted. Those reference experiments are hereinafter described.

### [Reference Experiment 1]

Particulate calcium hydroxide (3 g) was dissolved in pure water (15 ml) in a round flask at room temperature (20° C.). Particulate aluminum (3 g) was immersed in the solution to perform a hydrogen generation reaction. Five kinds of particulate aluminum having particle sizes of 10 μm, 45 μm, 90 μm, 150 μm and 250 μm were used. FIG. 2 shows the relationship between the total amount of hydrogen generation and time during the reaction. The reaction percentage approximately reached 100% when the aluminum with a particle size of 10 μm was used. However, under this condition, the hydrogen generation reaction proceeded at extremely high rates and ceased within approximately 5 minutes, as can be seen in FIG. 2.

When the particulate aluminum with a particle size of 250 μm was used, the reaction ceased with almost no hydrogen gas generated. The probable reason for this is that a passive layer was formed on the surface of the aluminum particles almost simultaneously with the beginning of the reaction, so that the reaction of the aluminum and water barely occurred.

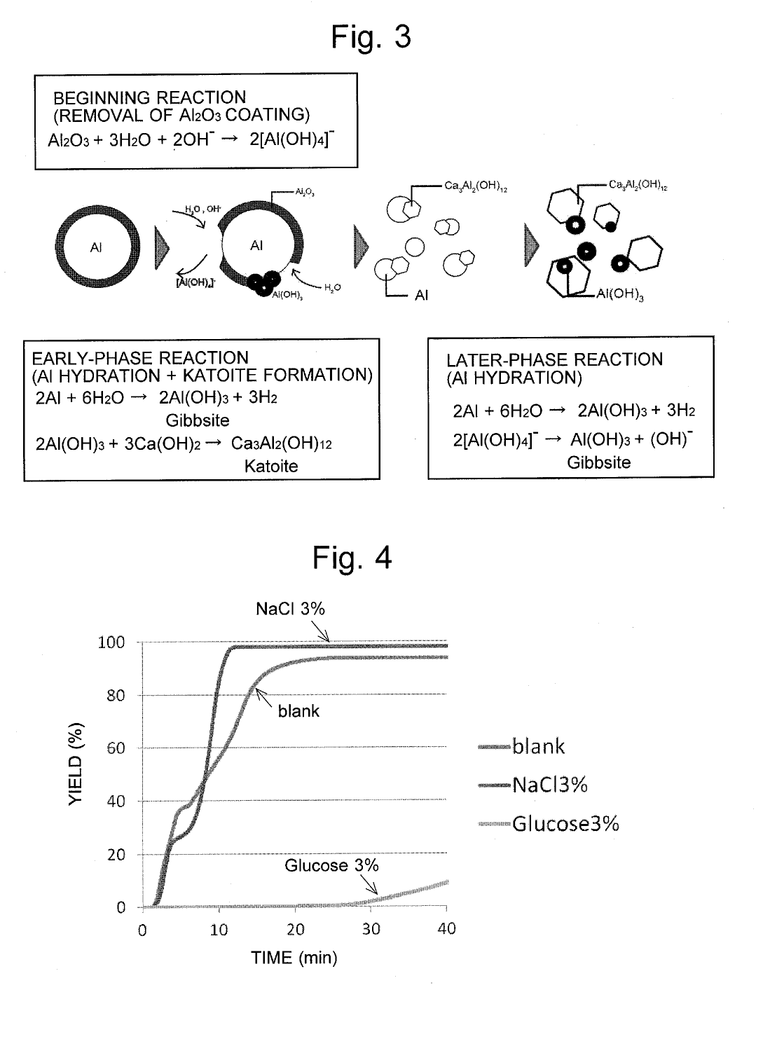

FIG. 3 shows the mechanism of the reaction of aluminum and water inferred from the previously described results. As shown in FIG. 3, the addition of calcium hydroxide is most likely to make the reaction of aluminum and water occur in three consecutive stages (beginning reaction, early-phase reaction, and late-phase reaction).

### [Reference Experiment 2]

Particulate calcium hydroxide (9 g) and particulate aluminum (9 g) with a particle size of 45 μm were added to pure water (200 ml) in a round flask and stirred. Furthermore, sodium chloride (6.0 g) or glucose (6.0 g) was added to perform a hydrogen generation reaction. The other conditions were the same as in Reference Experiment 1. FIG. 4 shows the temporal change in the amount of hydrogen generation in this experiment. For comparison, the result obtained with no additive (blank) is also shown in FIG. 4.

As can be seen in FIG. 4, when sodium chloride was added, the reaction was accelerated. The probable reason for this is that the chlorine ion (Cl⁻) causes the pitting corrosion reaction and thereby promotes the corrosion reaction of the aluminum particles. By comparison, when glucose was added, the reaction was suppressed and the generation of hydrogen did not begin until nearly 30 minutes had passed since the reaction was initiated. These results demonstrate that sodium chloride and glucose can be used as the additives for controlling the rate of reaction.

Hereinafter, specific examples of the present embodiment using the aluminum sheet (which is hereinafter called the “aluminum foil”) are described.

### Example 1

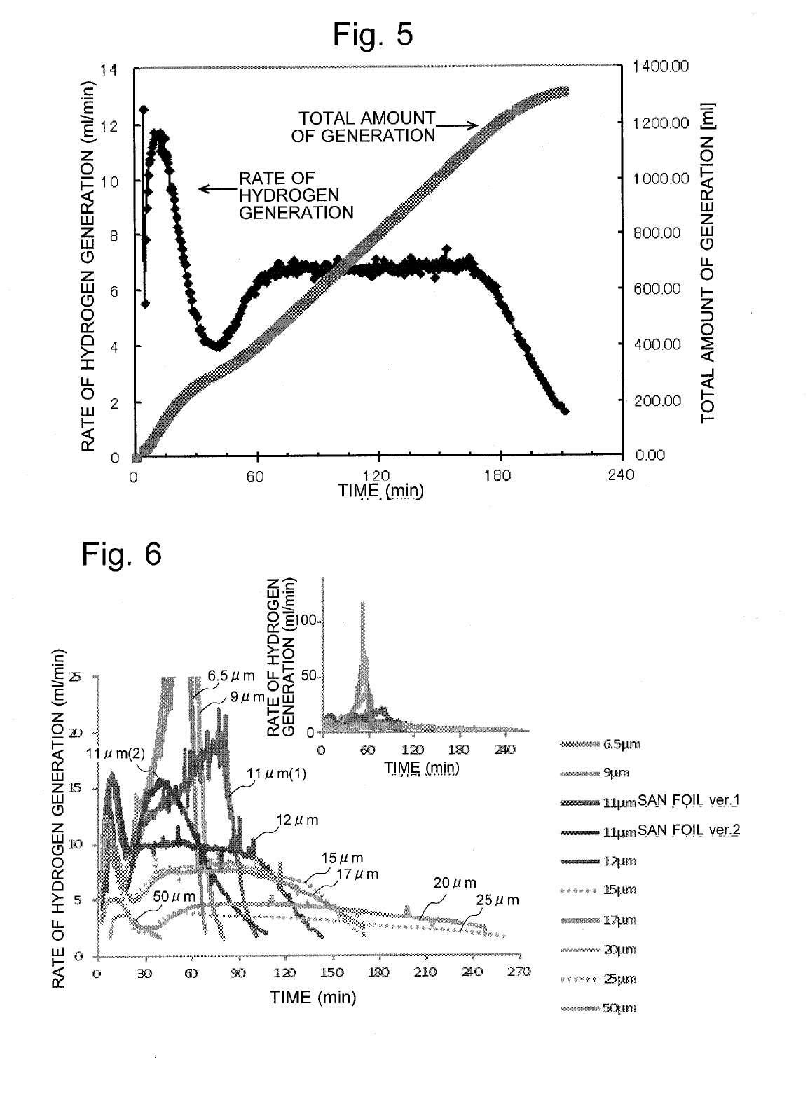

Pure water (95 ml) was poured in a rectangular acrylic container 3 with a capacity of 100 ml. After particulate calcium hydroxide (1 g) was dissolved in the water, 1 g of 12-μm-thick aluminum foil (manufactured by UACJ Foil Corporation, 1N30 (aluminum purity, 99.3% or higher)) cut into a strip was immersed in the solution to perform a hydrogen generation reaction. FIG. 5 shows the temporal change in the total amount of generation (ml) and the rate of generation (ml/min) of the hydrogen gas. The total amount of generation and the rate of generation were measured with a diaphragm-type meter.

As shown in FIG. 5, the rate of generation significantly fluctuated in the initial phase of the reaction. However, the rate of hydrogen generation began to be stabilized at around 60 minutes from the beginning of the reaction. After that, the hydrogen was generated at almost constant flow rates until around 180 minutes from the beginning of the reaction.

### Example 2

Pure water (25 g) was poured in a rectangular acrylic container 3 with a capacity of 100 ml. After particulate calcium hydroxide (1 g) was dissolved in the water, each of the 10 samples of aluminum foil (1 g) with different thicknesses cut into a strip was immersed in the solution to perform a hydrogen generation reaction. The rate of hydrogen-gas generation (ml/min) was measured during the reaction.

The thicknesses of the 10 samples of aluminum foil were as follows: 6.5 μm, 9 μm, 11 μm (two kinds), 12 μm, 15 μm, 17 μm, 20 μm, 25 μm, and 50 μm. As the 11-μm aluminum-foil samples, two kinds (ver. 1 and ver. 2) of “San Foil” (trade name) manufactured by Toyo Aluminium Ecko Products Co., Ltd. were used, while aluminum foil “1N30” manufactured by UACJ Foil Corporation was used as the other samples.

The area of each sample of aluminum foil was as follows:

6.5 μm: 1150 cm², 830 cm², 680 cm², 12 μm: 625 cm², 15 μm: 500 cm², 17 μm: 440 cm², 20 μm: 375 cm², 25 μm: 300 cm², and 50 μm: 150 cm².

FIG. 6 shows the temporal change in the rate of hydrogen generation for each sample of aluminum foil.

As can be seen in FIG. 6, the thinner the aluminum foil is, the shorter the duration of the hydrogen generation reaction becomes due to the higher rate of hydrogen generation in the initial phase of the reaction. The “San Foil” samples (ver. 1 and ver. 2) had the same thickness and area yet yielded different results. Accordingly, the reaction percentage of the two samples was investigated. The reaction percentage of ver. 1 was 96%, whereas that of ver. 2 was as low as 75%. An elemental analysis with an ICP emission spectrometer revealed that ver. 2 had a lower level of purity; the degrees of aluminum purity of ver. 1 and ver. 2 were 99% and 97%, respectively. Accordingly, it is most likely that the low degree of purity was the cause of the low reaction percentage.

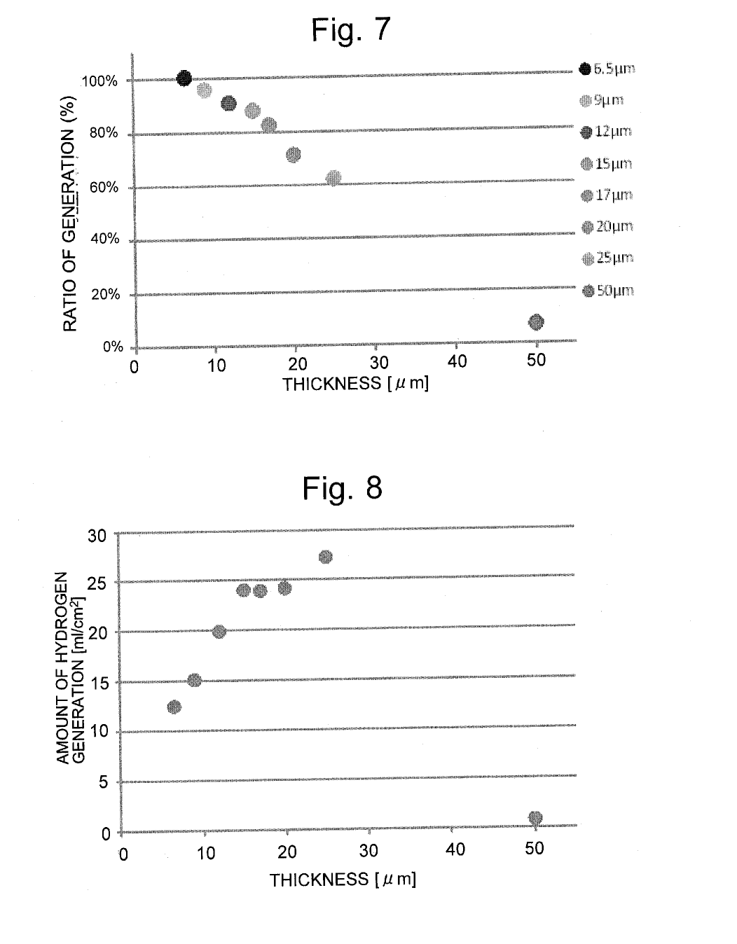

For the eight kinds of aluminum foil (1N30) manufactured by UACJ Foil Corporation, a hydrogen generation reaction was performed by the same method as used for the 10 aforementioned kinds of aluminum foil to investigate the relationship between the ratio of hydrogen generation and the thickness as well as the amount of hydrogen generation per unit area. The results are shown in FIGS. 7 and 8.

As can be seen in FIGS. 7 and 8, all samples of aluminum foil except for the 50-μm-thick sample showed an increase in the amount of hydrogen generation per unit area with the increasing thickness, while the ratio of hydrogen generation decreased with the increasing thickness.

### Example 3

Pure water (300 ml) was poured into a cylindrical glass container 3 with a capacity of 500 ml. After particulate calcium hydroxide (1 g) was dissolved in the water, each of the six samples of aluminum foil with different thicknesses (6.5 μm, 12 μm, 20 μm, 50 μm and 100 μm), which had been cut into an area of 200 mm×250 mm and further into 25-mm-square pieces, was immersed in the solution to perform a hydrogen generation reaction. The rate of hydrogen-gas generation (ml/min) gas was measured during the reaction. In the present example, the solution was agitated with a stirring bar placed in the glass container 3 during the hydrogen generation reaction. The rate of generation was measured with a diaphragm-type meter.

The weight of each sample of aluminum foil used in the present example was as follows:

6.5 μm: 1.01 g, 12 μm: 1.66 g, 17 μm: 2.19 g, 20 μm: 2.56 g, 50 μm: 6.55 g, and 100 μm: 13.24 g.

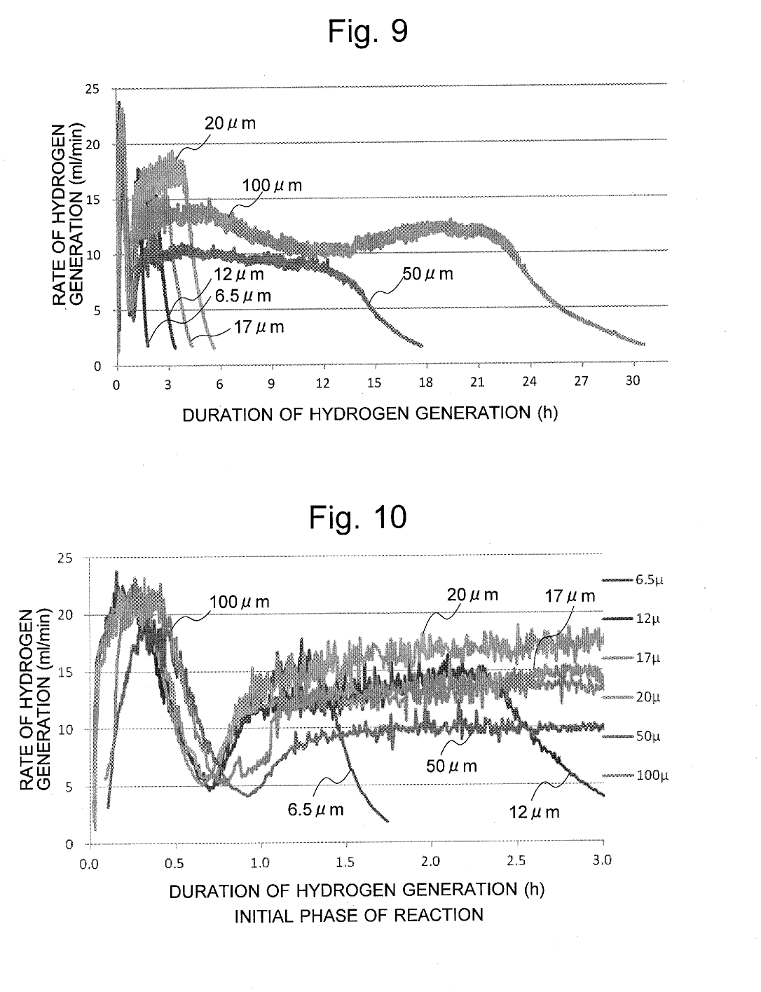

The result is shown FIGS. 9 and 10. FIG. 10 corresponds to a portion of FIG. 9 showing the rate of generation in the initial phase of the reaction, with the horizontal scale magnified.

The result shown in FIGS. 9 and 10 demonstrates that the duration of hydrogen generation increased with the increase in the thickness of the aluminum foil from 6.5 μm to 100 μm. Additionally, the reaction percentage of the aluminum was calculated from the total amount of hydrogen generation for each thickness. Unlike Example 2 in which the reaction percentage declined with the increasing thickness of the aluminum foil, the reaction percentage in the present example reached 95% or higher values with any of the samples. The probable reason for this is that the reaction products formed on the aluminum surface, such as aluminum hydroxide and calcium aluminate, were detached by the agitation, allowing the fresh metallic surface to be constantly exposed to the calcium hydroxide solution, so that the reaction could proceed completely and efficiently.

The temporal change in the rate of hydrogen generation was also investigated in a hydrogen generation reaction performed by the same method as previously described using a sample of aluminum foil with a thickness of 300 μm and an area of 200 mm×250 mm. The result is shown in FIG. 11, along with the result obtained for the 100-μm-thick aluminum foil.

The result shown in FIG. 11 demonstrates that the 300-μm-thick aluminum foil was roughly comparable to the 100-μm-thick sample in terms of the duration of the hydrogen generation. However, the reaction percentage of the aluminum was no higher than 30%. An investigation for the cause of this result revealed that the pieces of aluminum foil came in contact with the stirring bar during the reaction, and the stirring bar was bounced from the bottom of the container by those pieces of aluminum foil. From this finding, the most likely cause of the low reaction percentage is as follows: Since the stirring bar was prevented from being duly interlocked with the stirrer, the agitation was discontinued and the aluminum foil became in the immersed state from halfway in the hydrogen generation reaction, so that the reaction products could no longer be detached from the aluminum foil. Additionally, since the pieces of aluminum foil were piled at the bottom of the container, the contact area between the surface of the aluminum foil and the calcium hydroxide solution was reduced due to the weight of the pile.

Accordingly, if a structure for preventing the contact between the stirring bar and the aluminum foil is provided, such as a holder for suspending the aluminum foil in the container to prevent them from coming in contact with the bottom of the container, or a step portion or shelf member for keeping the aluminum foil at 1-2 cm or higher locations from the bottom of the container, the stirring bar can rotate without interruption during the hydrogen generation reaction and help the hydrogen generation reaction proceed efficiently. Consequently, the duration of hydrogen generation from the 300-μm-thick aluminum foil may possibly reach approximately three times the duration of hydrogen generation achieved with the 100-μm-thick aluminum.

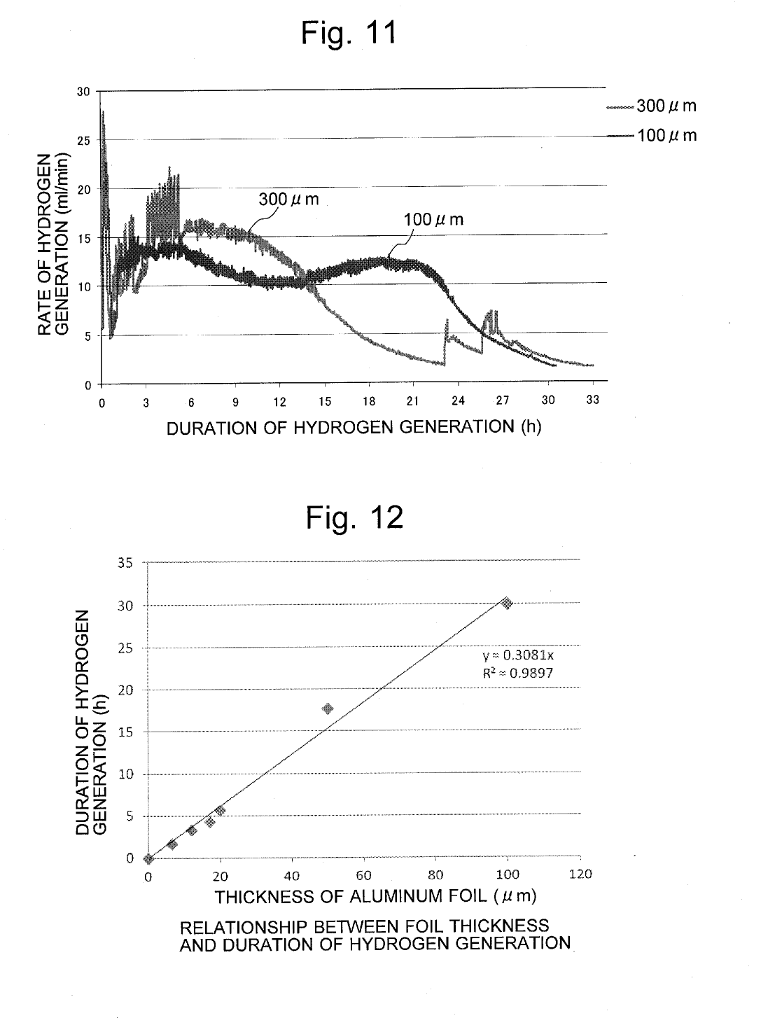

The relationship between the thickness of the aluminum foil and the duration of hydrogen generation was also investigated for the six samples of aluminum foil with the thicknesses from 6.5 μm to 100 μm. The result is shown in FIG. 12.

FIG. 12 demonstrates that the duration of hydrogen generation increases with the thickness of the aluminum foil.

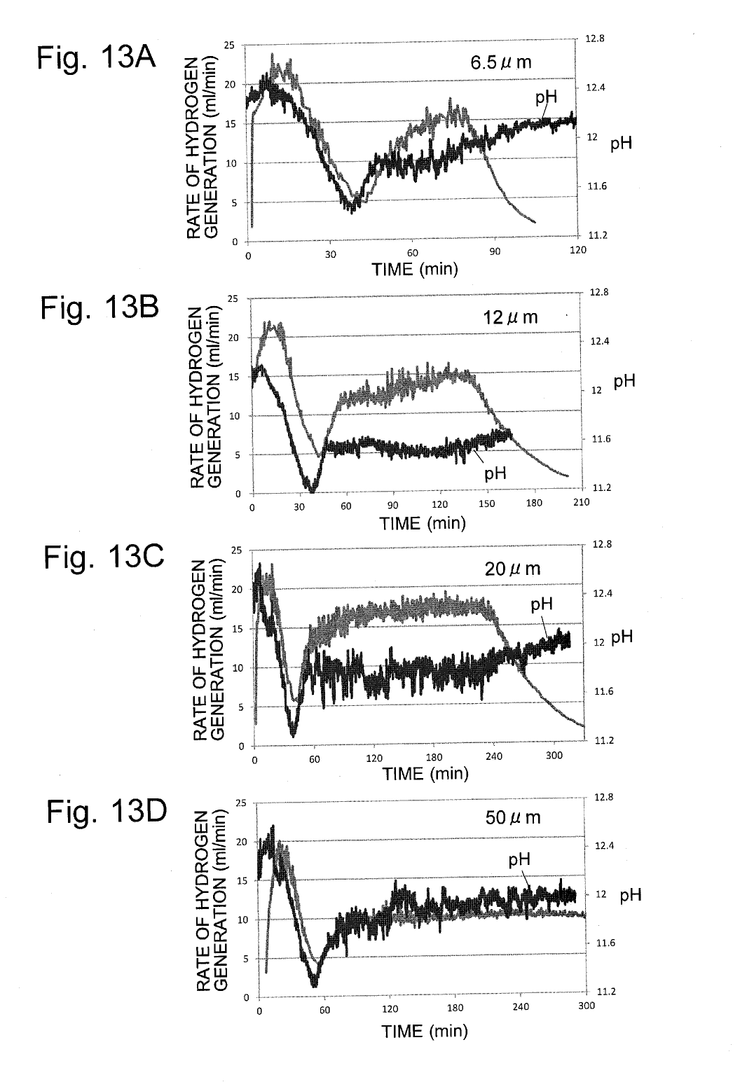

Additionally, using the aluminum-foil samples with the thicknesses of 6.5 μm, 12 μm, 20 μm and 50 μm, the hydrogen generation reaction was performed under the same experimental conditions as used in FIG. 10, and the change in the rate of hydrogen generation and the temporal change in pH during the reaction were investigated. The result is shown in FIGS. 13A-13D. FIGS. 13A-13D demonstrate that the rate of hydrogen generation follows the change in pH.

### Example 4

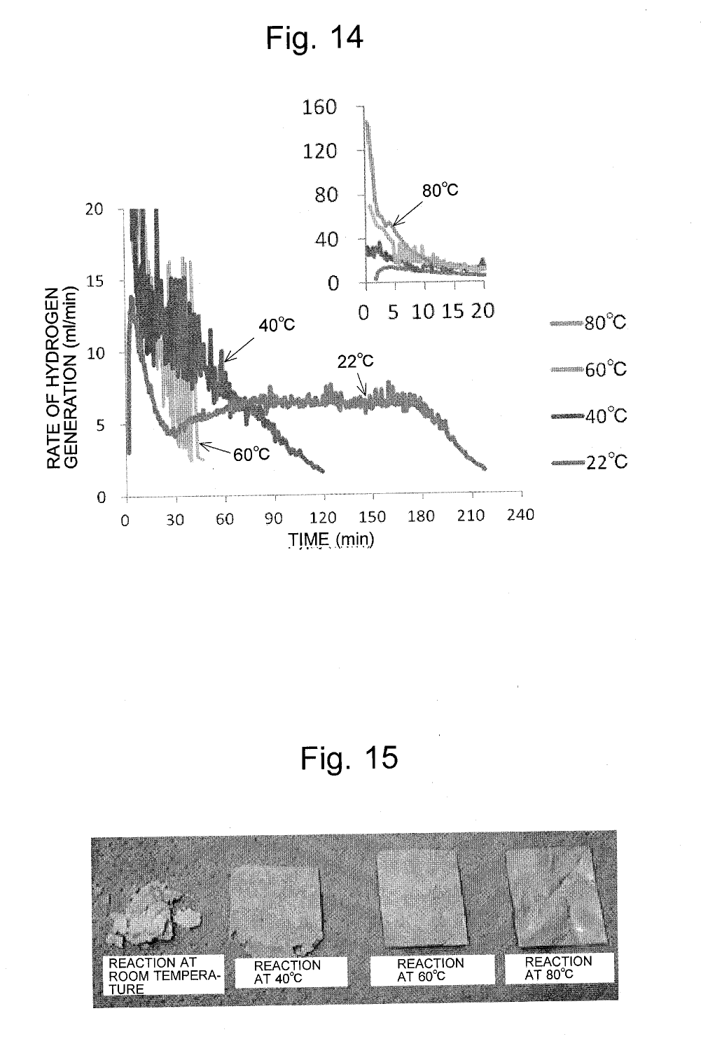

Pure water (100 ml) was poured into a rectangular acrylic container 3 with a capacity of 100 ml. After particulate calcium hydroxide (1 g) was dissolved in the water, 1 g of 12-μm-thick aluminum foil (manufactured by UACJ Foil Corporation, 1N30) cut into a strip was immersed in the solution to perform a hydrogen generation reaction with the reaction temperature set at 22° C., 40° C., 53° C. and 80° C. FIG. 14 shows the temporal change in the rate of hydrogen-gas generation (ml/min), and FIG. 15 shows a photograph showing the state of aluminum foil taken after the reaction was completed.

A comparison of the weights of the aluminum foil measured before the beginning of the reaction and after the completion of the reaction demonstrated that the yield was 97% when the reaction temperature was at 22° C. (room temperature), 70% at 40° C., 53% at 53° C., and 40% at 80° C.

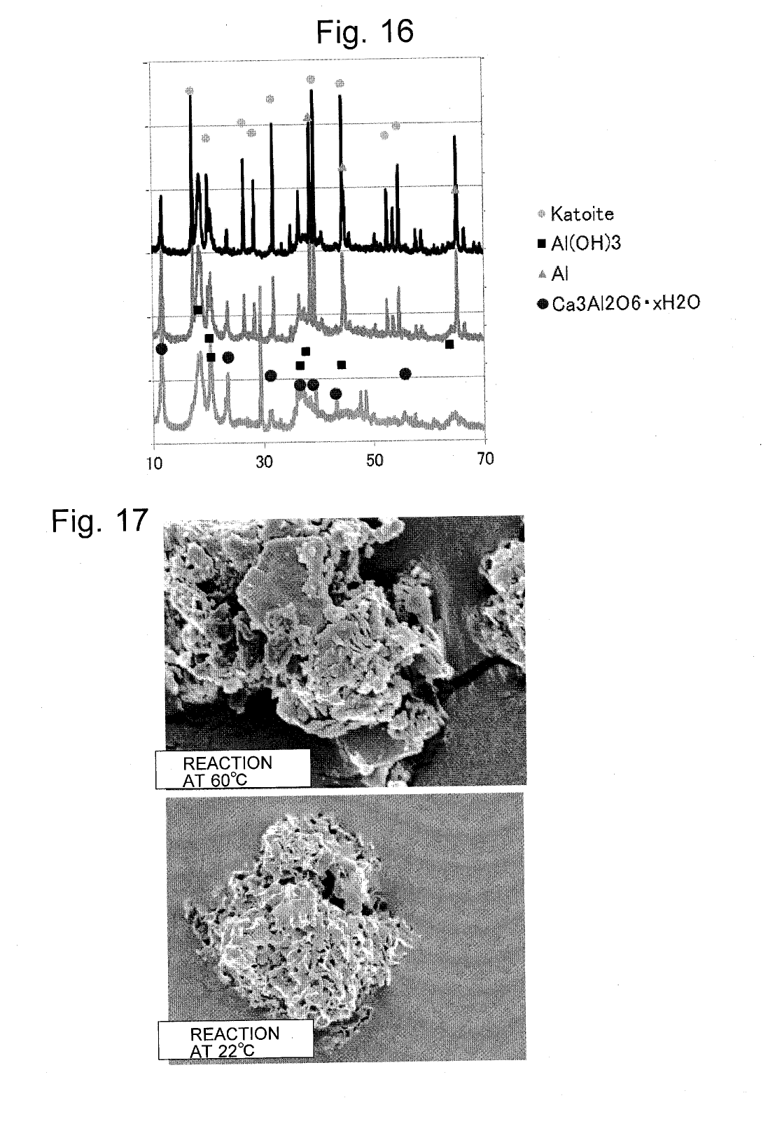

An X-ray structural analysis was performed for the aluminum-foil samples which had undergone the reaction at the reaction temperatures of 22° C., 40° C. and 60° C. The result is shown in FIG. 16. The result of the structural analysis suggests that, as the temperature increases, Katoite is formed on the surface of the aluminum foil and hardens the surface, so that the reaction cannot continue. SEM images of the aluminum-foil samples which underwent the reaction at 22° C. and 60° C. (FIG. 17) were taken. In the SEM image of the 60° C. sample, the precipitation of aluminum hydroxide on the Katoite surface could be observed.

These results suggest that, as the temperature increases, the reaction tends to cease in an early phase, and the middle-phase reaction becomes more dominant.

### Example 5

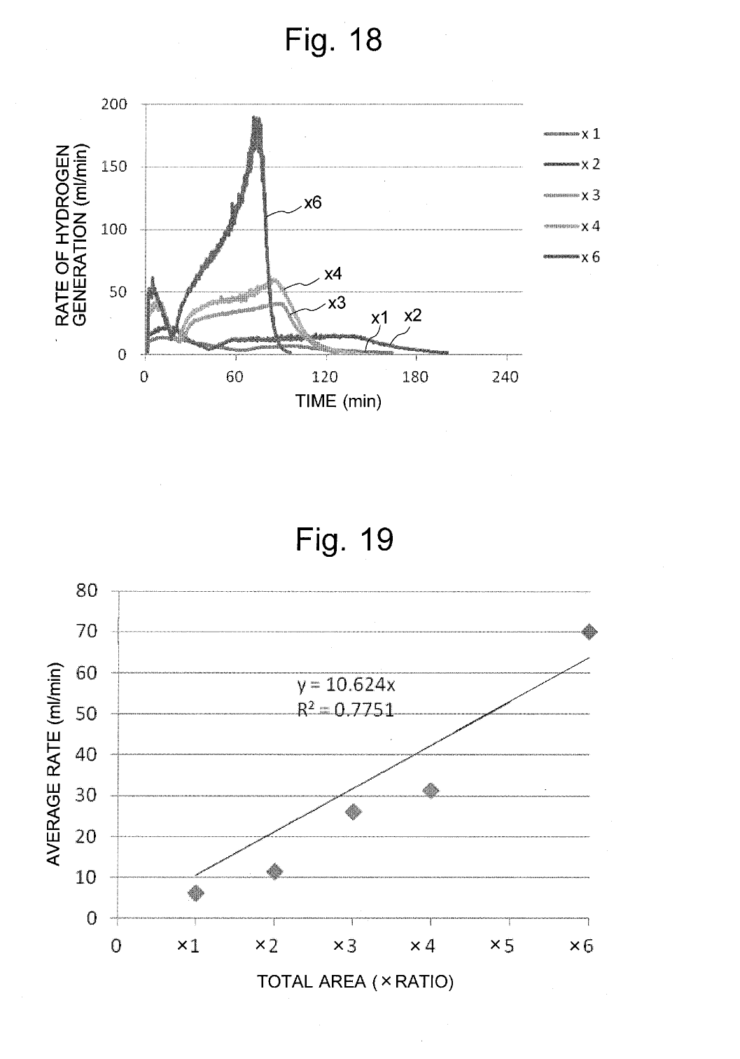

Pure water (300 ml) was poured into a cylindrical glass container 3 with a capacity of 500 ml. After particulate calcium hydroxide (1 g) was dissolved in the water, 12-μm-thick aluminum foil cut into 25-mm-square pieces was immersed in the solution, with the amount of foil (in total area) changed as follows: 100×250 mm2 (×1), 200×250 mm2 (×2), 300×250 mm2 (×3), 400×250 mm2 (×4) and 600×250 mm2 (×6). With the solution stirred, the rate of hydrogen generation was measured. The result is shown in FIG. 18. The magnification number in parenthesis which follows the numerical value of the total area represents the ratio with 100×250 mm² defined as 1.

Additionally, the average rate for each total area was calculated from the result shown in FIG. 18, and the relationship between the total area of the aluminum foil and the flow rate was determined. The result is shown in FIG. 19.

As can be seen in FIGS. 18 and 19, as the total area of the aluminum foil was increased, the rate of hydrogen generation also increased, with the corresponding increase in the average rate. The reaction percentage of the aluminum was at a level of 95% or higher for any of the total areas. The relationship between the area and the average flow rate was linear for all samples of aluminum foil except the one with a total area of 600×250 mm², whereas the 600×250-mm² sample deviated from the linear relationship. A probable reason for this is that the reaction of aluminum and water is an exothermal reaction: when the aluminum foil with the total area of 400×250 mm² was used, the reaction temperature was 38° C., whereas the reaction temperature reached 52° C. and exceeded 40° C. when the aluminum foil with the total area of 600×250 mm² was used. It is known that the reaction of aluminum and water becomes uncontrollable when the reaction temperature exceeds 40° C.

The results of Examples 1-5 demonstrate that the rate of hydrogen generation and the total amount of hydrogen generation can be controlled by appropriately setting the thickness and area (total surface area) of the aluminum foil (aluminum sheet). Therefore, if the hydrogen production system of the present invention is used as the hydrogen supply source for a fuel cell, it is possible to select the output and use time of the fuel cell to be used by an appropriate combination of the thickness and the total surface area of the aluminum sheet. Accordingly, the system is useful as the hydrogen-gas supply source for fuel cells.

Next, a hydrogen production system according to the second embodiment of the present invention is described.

As already explained, the reaction of the water and aluminum may cease halfway and decrease the reaction percentage due to some causes, such as the contact of the stirring bar with the aluminum sheet or the discontinuation of the rotation of the stirring bar. Accordingly, the present inventors conducted research on the method for sustaining the reaction of the aluminum with the water without using the stirring bar. As a result, the hydrogen production system according to the present embodiment has been obtained.

FIG. 20 shows the hydrogen production system 21 according to the second embodiment of the present invention. This hydrogen production system 21 has an acrylic container 23 with a lid, a folder 24 made of PET (polyethylene terephthalate) to be placed in the container, a roll of aluminum 25 held in the folder 24, and particulate calcium hydroxide 27 placed in the container 23. The container 23 in FIG. 20 has a cylindrical shape, although there is no specific limitation on its shape as long as it has a sufficient size for entirely containing the folder 24. As with the container 3 in the hydrogen production system 1, the container 23 has a discharge port 23a for discharging the generated hydrogen gas. A diaphragm-type meter 9 is connected to this discharge port 23a. The diaphragm-type meter 9 is connected to a PC 10, whereby the amount of generated hydrogen can be measured.

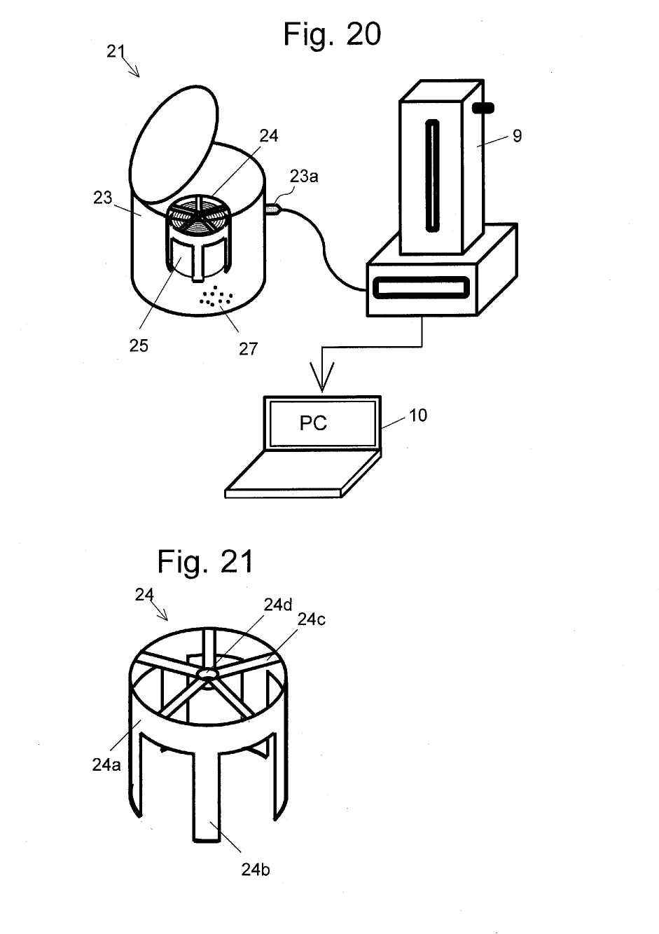

As shown in FIG. 21, the folder 24 has a cylindrical overall shape and is composed of a ring-shaped portion 24a, five thin rectangular pieces 24b extending downward from the lower end of the ring-shaped portion 24a, and five strip portions 24c radially extending from the cylindrical portion 24d located at the center of the upper opening of the ring-shaped portion 24a to the upper end of the ring-shaped portion 24a.

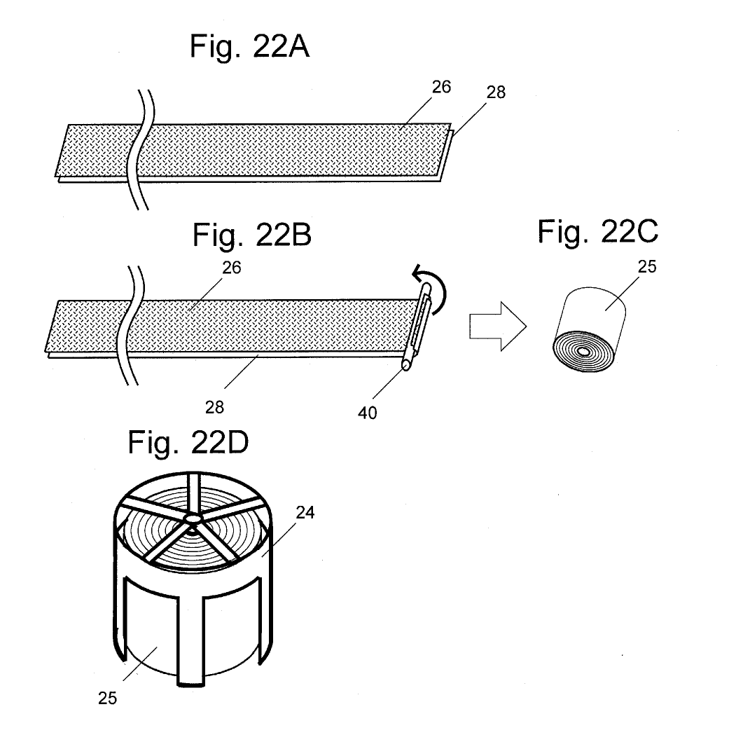

The roll of aluminum 25 includes an aluminum sheet 26 with a thickness of 12 μm, a width of 50 mm and a length of 3000 mm (manufactured by UACJ Foil Corporation, 1N30, 5 g in weight) in a rolled form. As shown in FIGS. 22A-22C, the roll of aluminum 25 is formed by laying, on the aluminum sheet 26, a spacer 28 having approximately the same size and shape as the aluminum sheet 26 (FIG. 22A), winding them around a core rod 40 a plurality of times (FIG. 22B), and removing the rod 40 (FIG. 22C).

The roll of aluminum 25 is contained in the folder 24 so that its center coincides with the cylindrical portion 24d of the folder 24 (FIG. 22D). In this state, the cylindrical portion 24d is inserted into the center of the roll of aluminum 25. This folder 24 with the roll of aluminum 25 contained inside is placed in the container 23, with the ring-shaped portion 24a directed upward (FIG. 20). When the roll of aluminum 25 is set in this manner, the aluminum sheet 26 in the rolled form is approximately perpendicular to the horizontal plane. (This state is hereinafter called the “vertically set state”.)

Hereinafter, specific examples of the hydrogen-gas generation reaction performed using the hydrogen generation system 21 according to the present embodiment are described. The stirring bar was not used in any of the following examples.

### Example 6

In the present example, a piece of toilet paper (trade name “Nepia Long Roll (Double)”, manufactured by Oji Nepia Co., Ltd.), which is a water-absorbing material, measuring 50 mm in width and 3000 mm in length was used as the spacer 28.

Initially, 5 g of calcium hydroxide 27 was placed at the bottom of the container 23. After the roll of aluminum 25 held in the folder 24 was placed in the vertically set state within the container 23, 400 ml of pure water was poured into the container 23 to entirely immerse the roll of aluminum 25 in the pure water and thereby perform a hydrogen generation reaction.

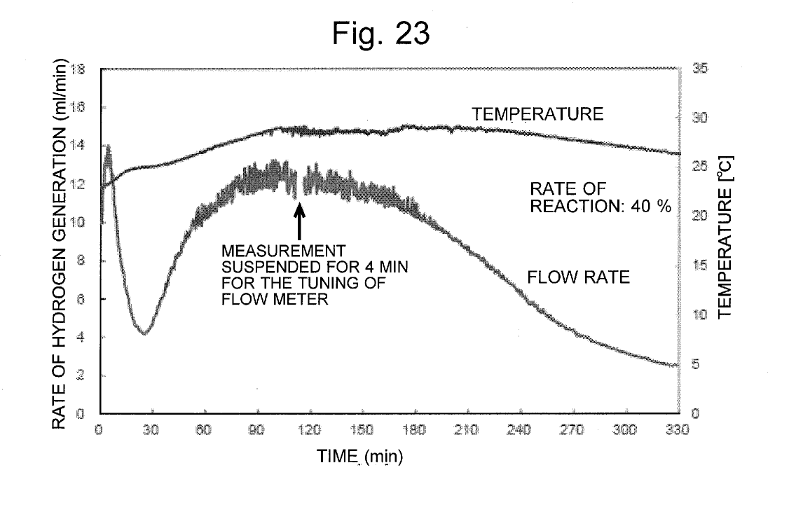

During this reaction, the rate of hydrogen-gas generation (flow rate, in ml/min) was measured with the diaphragm-type meter 9. The temperature in the hydrogen generation reaction was also measured. The temporal change in the rate of generation and the temperature is shown in FIG. 23. As can be seen in FIG. 23, the rate of generation considerably fluctuated in the initial phase of the reaction. While the elapsed time from the beginning of the reaction was within a range from approximately 60 minutes to 180 minutes, the rate of generation was stabilized and constantly maintained within a range of 10-14 (ml/min). After that period, the rate of hydrogen generation gradually decreased. However, the generation of hydrogen was observed even at 330 minutes from the beginning of the reaction. The reaction percentage of the aluminum calculated from the total amount of hydrogen generation was 40%. The temperature from the beginning of the reaction to 330 minutes was within a range from approximately 22° C. to approximately 29° C.

In the present embodiment in which the hydrogen generation reaction was performed with the aluminum held in the vertically set state, unlike the case where the aluminum sheet was stirred in the aqueous solution, no bubbles were formed and the toilet paper retained its original form. Therefore, the aluminum could continuously react with the water absorbed in the toilet paper for a long period of time.

Another possible effect is that the spacer ensures the formation of the gaps between the layers of the roll of aluminum, so that the reaction efficiency of the aluminum and water is improved as well as the passages for the hydrogen generated by the reaction of the aluminum and water are secured between the layers of the roll of aluminum.

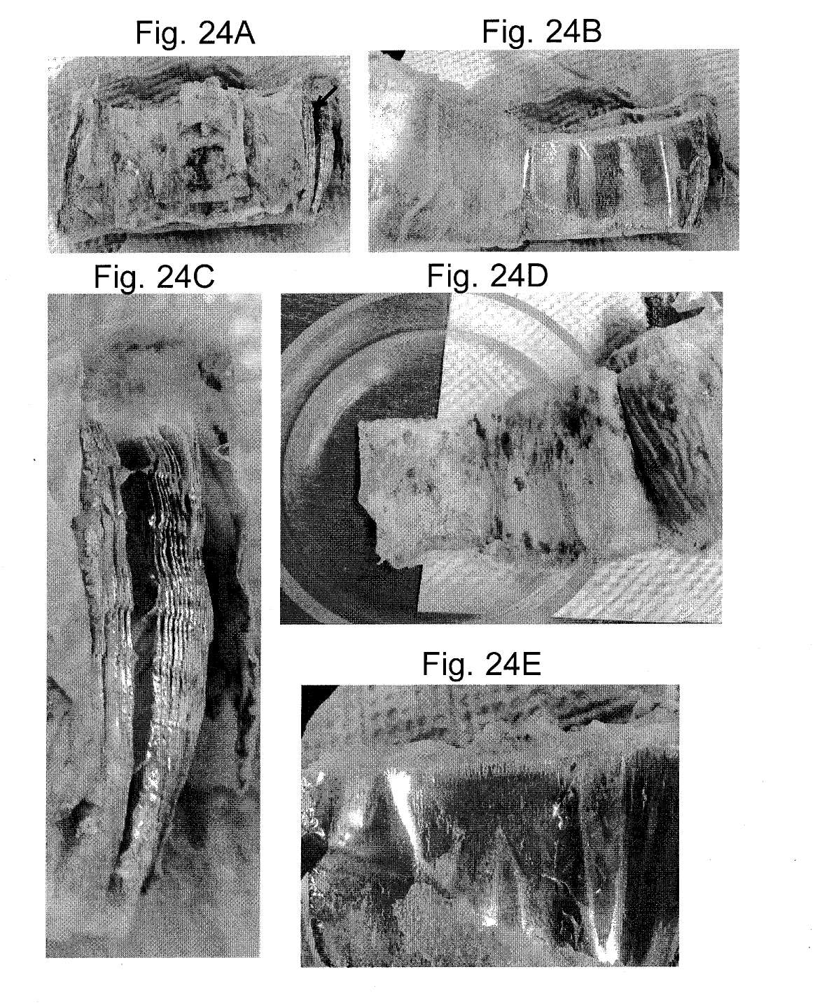

FIGS. 24A-24E are photographs of the roll of aluminum 25 taken after the reaction was completed, with the roll vertically cut and spread.

As can be seen in FIGS. 24A-24E, the aluminum was corroded over the entire area in the layer near the center of the roll of aluminum 25 as well as on the outermost layer. In the other layers, the corrosion only occurred at their upper and lower ends, leaving considerable amounts of unreacted portions. From FIGS. 24D and 24E, it is reasonable to consider that the water was indeed present between the layers of the roll of aluminum 25 due to the absorbing capacity of the toilet paper. It seems that the reaction of the roll of aluminum 25 with the water continued in such portions where the aluminum was exposed to the solution composed of the pure water and calcium hydroxide, whereas the reaction with the water ceased halfway in the other portions.

The previously described results suggest that the mere presence of water is not enough to sustain the hydrogen generation reaction; it is necessary to remove the passive layer (Al₂O₃ coating) by the calcium ion and hydroxide ion.

When the hydrogen generation reaction was performed using the aluminum sheet cut into 25-mm-square pieces without the stirring operation, a gray-colored layer of aluminum residue was formed on the calcium hydroxide layer at the bottom of the container. By comparison, in the present example using the roll of aluminum 25, no such layer of aluminum residue was observed on the calcium hydroxide layer at the bottom of the container 23.

### Example 7

To investigate the influence of the presence of the calcium ion and hydroxide ion between the layers of the roll of aluminum 25 on the hydrogen generation reaction, the hydrogen generation reaction described in Example 6 was similarly performed using a roll of aluminum 29 in place of the roll of aluminum 25.

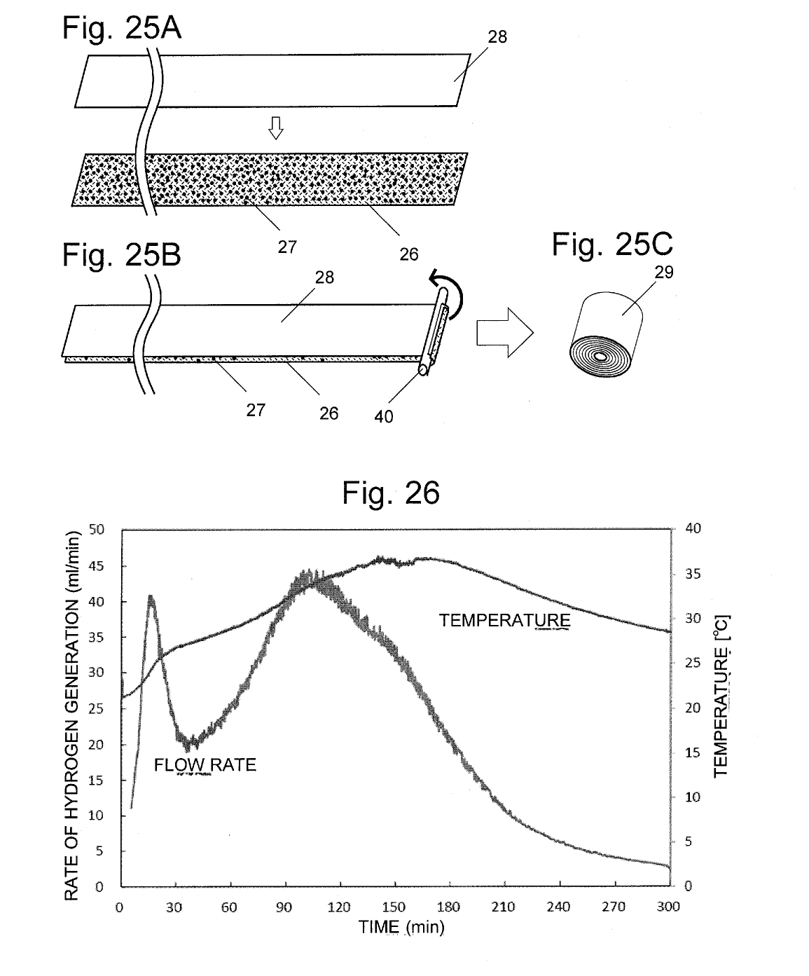

As shown in FIGS. 25A-25C, the roll of aluminum 29 is prepared by almost evenly distributing 5 g of particulate calcium hydroxide over the entire aluminum sheet 26, laying a spacer 28 made of toilet paper on the aluminum sheet 26, and winding them a plurality of times. In the present embodiment, no calcium hydroxide 27 is placed at the bottom of the container 23, since the calcium hydroxide 27 is held between the roll of aluminum 29 and the spacer 28. The other conditions are the same as in Example 6.

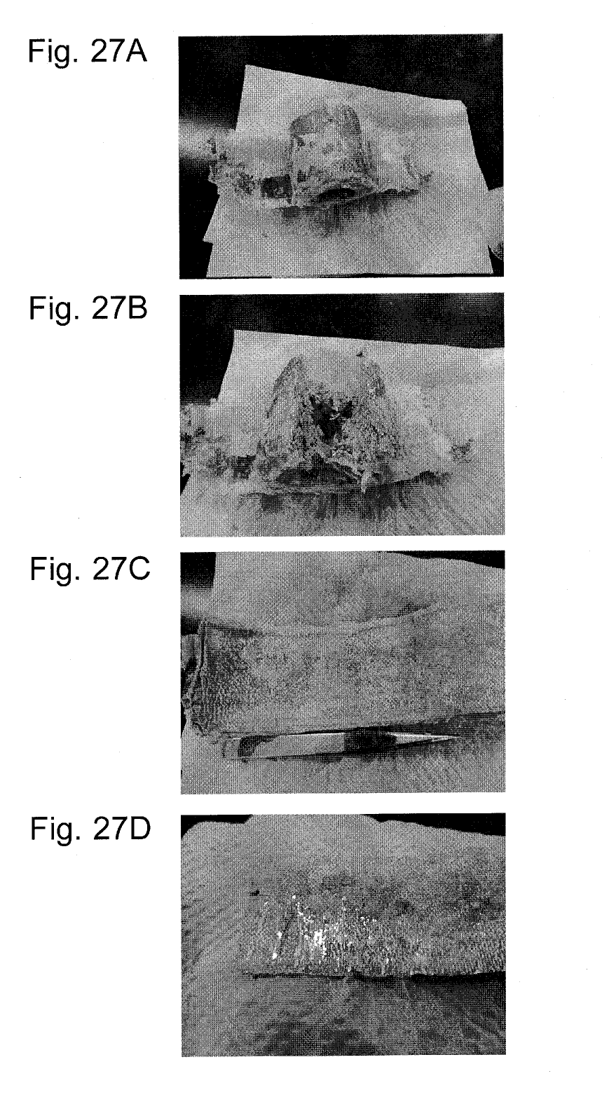

FIG. 26 shows the temporal change in the rate of hydrogen-gas generation (ml/min) and the temperature in the present example. FIGS. 27A-27D are photographs of the roll of aluminum 29 taken after the reaction was completed, with a portion or the entirety of the roll vertically cut and spread.

As can be seen in FIG. 26, the rate of generation considerably fluctuated in the initial phase of the reaction, similarly to Example 6. However, unlike Example 6, the rate of generation began to steeply increase at around 60 minutes from the beginning of the reaction and reached the levels around 45 ml/min when 100 minutes had passed. After that, the rate of generation rapidly decreased; it fell to 10 ml/min at around 210 minutes from the beginning of the reaction, and further to 2.5 ml/min at around 300 minutes. The reaction percentage of the aluminum calculated from the total amount of hydrogen generation was 97%. The temperature of the aqueous solution, which was approximately 20° C. immediately after the reaction began, gradually increased and exceeded 35° C. at around 140 minutes from the beginning of the reaction. At around 180 minutes from the beginning of the reaction, the temperature began to gradually decrease but did not fell below 30° C. until 270 minutes had passed since the reaction was initiated.

As can be seen in FIGS. 27A-27D, in the present example, the corrosion progressed in the entire roll of aluminum 29. Furthermore, as shown in FIG. 27A, even after the aluminum was considerably corroded, most of the residual aluminum was retained on the spacer 28, so that the shape of the roll of aluminum 29 was maintained.

As just described, the present example was superior to Example 6 in any of the following aspects: the rate of hydrogen generation, reaction percentage of the aluminum, and area of the corrosion of the aluminum. The probable reason for this is that the formation of the passive layer was suppressed in the entire roll of aluminum 29 due to the use of the spacer 28 made of the toilet paper which is a water-absorbing material as well as the placement of the calcium hydroxide 27 between the spacer 28 and each layer of the roll of aluminum 29. In particular, toilet paper has a large number of small pores, in which the particulate calcium hydroxide 27 can be fitted and held. Therefore, it is probable that the calcium hydroxide 27 was prevented from being washed away from between the layers of the roll of aluminum 29, so that the reaction of the aluminum and water could continue for an even longer period of time.

### Example 8

To investigate the function of the spacer 28 in the roll of aluminum 29, the hydrogen generation reaction in Example 7 was similarly performed using photocopy paper, mesh and a glass-fiber sheet as the spacer 28 in addition to the toilet paper. As the photocopy paper, a piece of recycled PPC paper manufactured by Daio Paper Corporation was used. As the mesh, “Crown Net” (mesh size, 0.84 mm) manufactured by Dio Chemicals Ltd., which is used in screen doors, was used. As the glass-fiber sheet, a piece of glass-fiber cloth manufactured by Sogo Laboratory Glass Works Co., Ltd. was used.

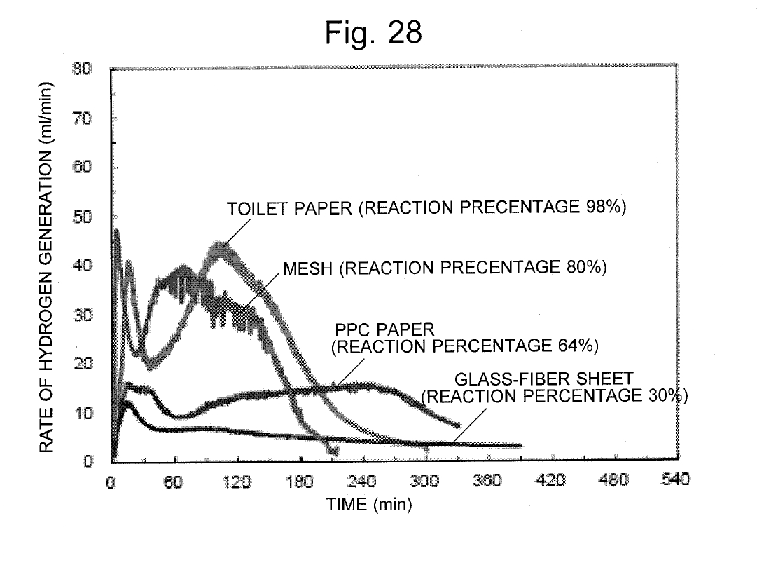

FIG. 28 shows the temporal change in the rate of hydrogen-gas generation (ml/min) during the reaction. The reaction percentage of the aluminum with those spacers 28, in descending order, was 98% for the toilet paper, 80% for the mesh, 64% for the photocopy paper, and 30% for the glass-fiber sheet. As can be seen in FIG. 28, when the toilet paper or mesh was used as the spacer 28, the reaction percentage of the aluminum was higher than when the photocopy paper or glass-fiber sheet was used. However, the hydrogen generation reaction proceeded rapidly, and the reaction almost completely ceased at 300 minutes (toilet paper) or 210 minutes (mesh) from the beginning of the reaction. When the photocopy paper was used as the spacer 28, although the rate of hydrogen generation was low, its fluctuation was small and the hydrogen generation reaction proceeded slowly. After the elapsed time from the beginning of the reaction exceeded 170-200 minutes, the rate of hydrogen generation for the photocopy paper exceeded the rates of hydrogen generation for the toilet paper and mesh. By comparison, when the glass-fiber sheet was used, the rate of generation was low from the beginning of the reaction. Its reaction percentage was also lower than those of the other samples.

The glass-fiber sheet does not have the water-absorbing capacity which the toilet paper or photocopy paper has, nor does it have any pores as in the toilet paper or mesh in which particulate calcium hydroxide can be fitted. These are the likely reasons why the glass-fiber sheet could not allow water, calcium ion and hydroxide ion to exist between the layers of the roll of aluminum 29. By comparison, toilet paper is highly water-absorptive. Furthermore, by absorbing water, toilet paper can swell and widen the gap between the layers of the roll of aluminum 29. These are the likely reasons why the toilet paper could produce the effects of helping the efficient reaction of the aluminum and water as well as suppressing the formation of the passive layer by the calcium ion and hydroxide ion.

In summary, a material which is highly water-absorptive and also capable of swelling by water absorption is suitable as the spacer, such as toilet paper as well as other kinds of paper, cloth and non-woven fabric having a large number of small pores.

### Example 9

The influence of the amount of calcium hydroxide 27 retained between the layers of the roll of aluminum 29 on the hydrogen generation reaction was confirmed by the following two experiments.

(I) Experiment Using Hydrogen Production System 1 According to First Embodiment

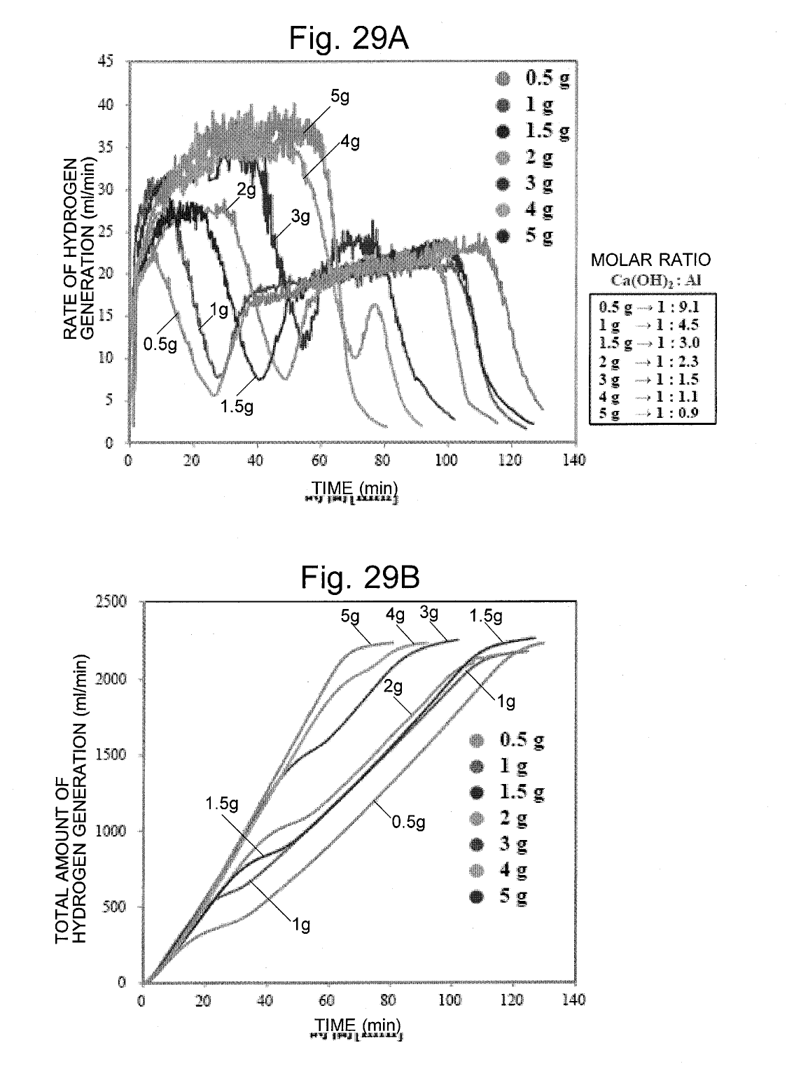

A piece of 12-μm-thick aluminum sheet (manufactured by UACJ Foil Corporation, 1N30, 1.6 g in weight) measuring 20 cm×25 cm was immersed in an aqueous solution prepared by dissolving calcium hydroxide 27 (0.5 g, 1 g, 1.5 g, 2 g, 3 g, 4 g or 5 g) in 300 ml of pure water to perform a hydrogen generation reaction with the stirring operation. FIG. 29A shows the temporal change in the rate of hydrogen-gas generation (ml/min) during the reaction, and FIG. 29B shows the temporal change in the amount of generated hydrogen gas (total amount of hydrogen generation).

As can be seen in FIG. 29A, when the amount of calcium hydroxide 27 was within the range from 0.5 g to 4 g, the rate of hydrogen generation initially increased from the very beginning of the reaction and then temporarily decreased. Subsequently, the rate of hydrogen generation once more increased, and after a certain period of time, the rate decreased and the hydrogen generation reaction ceased. The period of time from the beginning of the reaction to the temporal decrease in the rate of hydrogen generation tended to be shorter as the amount of calcium hydroxide 27 became smaller. The period of time from the re-increase in the rate of hydrogen generation to the end of the hydrogen generation reaction tended to be longer as the amount of calcium hydroxide 27 became smaller.

When the amount of calcium hydroxide 27 was 5 g, the increase in the rate of hydrogen generation from the beginning of the reaction continued for approximately 60 minutes. Subsequently, the rate decreased and the hydrogen generation reaction ceased. In other words, the temporary decrease in the rate of hydrogen generation did not occur when the amount of calcium hydroxide 27 was 5 g.

On the other hand, as shown in FIG. 29B, the total amount of hydrogen generation was not affected by the amount of calcium hydroxide; in any of those cases, the hydrogen generation reaction proceeded to almost 100%.

(II) Experiment Using Hydrogen Production System 21 According to Second Embodiment

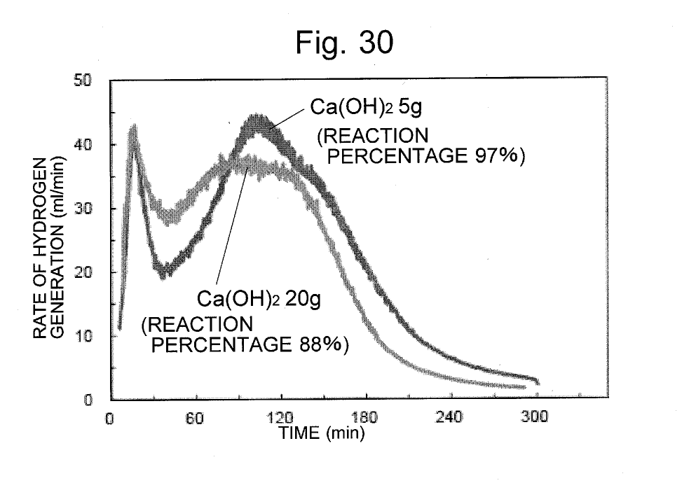

The result of Experiment (I) suggested that using a high amount of calcium hydroxide would eliminate the temporary decrease in the rate of hydrogen generation. Accordingly, a hydrogen generation reaction similar to Example 7 was performed, with the amount of calcium hydroxide 27 retained between the layers of the roll of aluminum 29 increased to 20 g. FIG. 30 shows the temporal change in the rate of hydrogen-gas generation (ml/min) during the reaction. For comparison, the result of Example 7 is also shown in FIG. 30. The reaction percentage of the aluminum in the present experiment was 88%.

As shown in FIG. 30, in the case of the hydrogen production system 21 of the second embodiment, the temporal decrease in the rate of hydrogen generation could not be completely eliminated by increasing the amount of calcium hydroxide 27 to 20 g. However, the amount of decrease in the rate of hydrogen generation was smaller than in the case where the amount of calcium hydroxide 27 was 5 g.

The present invention is not limited to the previously described examples but can be appropriately changed.

For example, the folder may be made of any material and have any shape as long as it can securely hold the roll of aluminum within the hydrogen generation container and yet does not prevent the contact of the held roll of aluminum with the water.

The hydrogen generation agent contained in the hydrogen generation container according to the present invention is not limited to aluminum. It is also possible to use magnesium, silicon, zinc or other kinds of metal. Calcium hydroxide may be replaced by potassium hydroxide, sodium hydroxide or similar compounds.

### REFERENCE SIGNS LIST

1, 21 . . . Hydrogen Generation System

3, 23 . . . Container

3a, 23a . . . Discharge Port

5, 26 . . . Aluminum Sheet

7, 27 . . . Calcium Hydroxide

9 . . . Diaphragm-Type Meter

10 . . . Personal Computer

24 . . . Folder

25, 29 . . . Roll of Aluminum

28 . . . Spacer

1. A hydrogen production method, wherein hydrogen gas is produced by immersing one or a plurality of aluminum sheets in a vertically set state in an aqueous solution of calcium hydroxide.

2. The hydrogen production method according to claim 1, wherein the plurality of the aluminum sheets are placed in the vertically set state, and a spacer is inserted between the neighboring the aluminum sheets.

3. A hydrogen production method, wherein hydrogen gas is produced by immersing a roll of aluminum in a vertically set state in an aqueous solution of calcium hydroxide, the roll of aluminum including an aluminum sheet wound a plurality of times.

4. The hydrogen production method according to claim 3, wherein a spacer is inserted between layers of the roll of aluminum.

5. The hydrogen production method according to claim 2, wherein the spacer is made of a water-absorbing material, and particulate calcium hydroxide is held in the spacer.

6. A hydrogen production system, comprising:
a) a container for holding water;
b) a roll of aluminum, placed in a vertically set state in the container, including an aluminum sheet wound a plurality of times; and
c) particulate calcium hydroxide contained in the container.

7. The hydrogen production system according to claim 6, wherein a spacer is inserted between layers of the roll of aluminum.

8. The hydrogen production system according to claim 7, wherein the spacer is made of a water-absorbing material, and particulate calcium hydroxide is held in the spacer.

9. The hydrogen production system according to claim 6, further comprising:
d) a folder to be placed in the container, for holding the roll of aluminum.

10. A hydrogen production method, including steps of:
preparing an aqueous solution by dissolving calcium hydroxide in water; and
immersing an aluminum sheet having a total surface area within a range from 150 cm² to 3000 cm² in the aqueous solution to generate hydrogen gas.

11. The hydrogen production method according to claim 10, further including the steps of:
preparing a plurality of kinds of aluminum sheet with different thicknesses; and
selecting one kind of aluminum sheet having a thickness corresponding to an amount of hydrogen gas to be generated, and immersing that selected kind of aluminum sheet in the aqueous solution to generate hydrogen gas.

12. The hydrogen production method according to claim 11, wherein the plurality of kinds of aluminum sheet have thicknesses ranging from 6.5 μm to 100 μm.

13. The hydrogen production method according to claim 11, wherein one kind of aluminum sheet having an appropriate thickness for the amount of hydrogen gas to be generated is selected based on a previously determined correlation between the thickness of the aluminum sheet and the amount of hydrogen generation.

14. The hydrogen production method according to claim 10, wherein the aqueous solution further contains glucose.

15. A hydrogen production system, comprising:
a) a container for holding water;
b) an aluminum sheet, placed in the container, having a total surface area within a range from 150 cm² to 3000 cm²; and
c) particulate calcium hydroxide contained in the container.

16. The hydrogen production system according to claim 15, wherein:
the container is provided with a holding part capable of holding a plurality of aluminum sheets in a mutually separated form; and
a plurality of the aluminum sheets are held in the holding part.

17. The hydrogen production system according to claim 16, wherein:
a plurality of aluminum sheets having an appropriate thickness for an amount of hydrogen gas to be generated among a plurality of kinds of aluminum sheet with different thicknesses are held in the holding part.

18. The hydrogen production system according to claim 17, wherein the plurality of kinds of aluminum sheet have thicknesses ranging from 6.5 μm to 100 μm.

19. The hydrogen production system according to claim 15, wherein glucose is further contained in the container.

20. The hydrogen production method according to claim 4, wherein the spacer is made of a water-absorbing material, and particulate calcium hydroxide is held in the spacer.
